(19) United States
(12) Patent Application Publication
(10) Pub. No.: US 2011/0043368 A1
(43) Pub. Date: Feb. 24, 2011

(54) THERMOMETER

(76) Inventor: Hsueh-Yu Lu, Taoyuan (TW)

Correspondence Address: Yen Jung Sung, 30-47 37 St., Astoria, NY, 11103, US

(21) Appl. No.: 12/544,222

(22) Filed: Aug. 20, 2009

(51) Int. Cl. G08B 17/00

(52) U.S. Cl. 340/586

(57) ABSTRACT

A thermometer includes a housing carrying a LCD screen having separated body temperature display zone and alert display zone that have different background colors, and a control module, which drives the body temperature display zone to display the value of the measured body temperature of a person and drives the alert display zone to display or to flash an alert icon when the measured body temperature surpasses a predetermined reference temperature value.

### BACKGROUND OF THE INVENTION

1. Field of the Invention

The present invention relates to a thermometer for clinical application and more particularly, to such a thermometer that produces a warning signal when the measured body temperature surpasses a predetermined reference temperature value.

2. Description of the Related Art

When a person is sick, the body temperature usually will rise. Therefore, when one feels uncomfortable, it is necessary to measure the body temperature before visiting a doctor or examination by a doctor. Many electronic thermometers, thermocouples and infrared thermometers are commercially available. These body temperature measuring implements are inexpensive and easy to use. FIG. 7 illustrates an electronic thermometer according to the prior art. According to this design, the electronic thermometer has a LCD panel A controllable to display the measured body temperature by digits. However, if a part of the LCD panel A is damaged, the LCD panel A may be unable to display the measured temperature value correctly. For example, the digits of 6, 8 and 0 are similar in configuration. When a part of the LCD panel A is damaged, the user may be unable to read the displayed digits correctly.

U.S. Pat. No. 7,350,973 discloses a thermometer entitled “Color changing thermometer”, which comprises: a temperature sensor; a processor determining a temperature of the living being based on the temperature sensor; a memory storing: information corresponding to a first range of temperatures, the first range indicating a normal temperature; and information corresponding to a second range of temperatures, the second range indicating a fever condition; a display including a first color light and a second color light for creating light of a first color and a second color; and a common housing that houses the temperature sensor, the processor, the memory and the display. The processor accesses the memory and compares the temperature to the temperature range information stored in the memory and illuminates one of the first and the second color light based on the temperature.

The above U.S. Pat. No. 7,350,973 visually displays ranges of body temperature for enabling the user to know the situation; however this design of thermometer still has drawbacks as follows:

(1) A user must know the meaning of each color of light before using the thermometer. To a user firstly using the thermometer may make a wrong determination of the detection result. A color-blind patient may be unable to use the thermometer.

(2) Because the temperature reading and the light of first or second color are displayed on one same surface, the user may be unable to read the temperature reading when the light source lights up the display. If the user is in a fever condition, the user may be unable to know the actual body temperature, making a wrong judgment on the situation of disease.

### SUMMARY OF THE INVENTION

The present invention has been accomplished under the circumstances in view. It is one object of the present invention to provide a thermometer, which produces a visual alert signal when the measured body temperature surpasses a predetermined reference temperature value.

To achieve this and other objects of the present invention, a thermometer comprises a housing carrying a LCD screen, a control module mounted inside the housing, a metal temperature sensing probe fixedly fastened to one end of the housing and electrically connected to the control module by a temperature-sensing electric wire, and a power source mounted inside the housing and electrically connected with the control module and the LCD screen to provide them with the necessary working voltage. The LCD screen defines a temperature display zone for displaying the body temperature of a person been measured and a separated alert display zone for displaying an alert icon. The temperature display zone and the alert display zone each have a different background color. The control module is adapted to receive a detected analog temperature signal from the metal temperature sensing probe, to convert the analog temperature signal into a digital temperature data, to drive on the temperature display zone of the LCD screen for the display of the digital temperature data, to compare the value of the digital temperature data with a predetermined reference temperature value stored therein and to drive on the alert display zone of the LCD screen in giving an alert signal when the value of the digital temperature data surpasses the predetermined reference temperature value.

### BRIEF DESCRIPTION OF THE DRAWINGS

FIG. 1 is a top plain view of a thermometer in accordance with the present invention.

FIG. 2 is a schematic sectional side view of the thermometer in accordance with the present invention.

FIG. 3 is a circuit block diagram of the thermometer in accordance with the present invention.

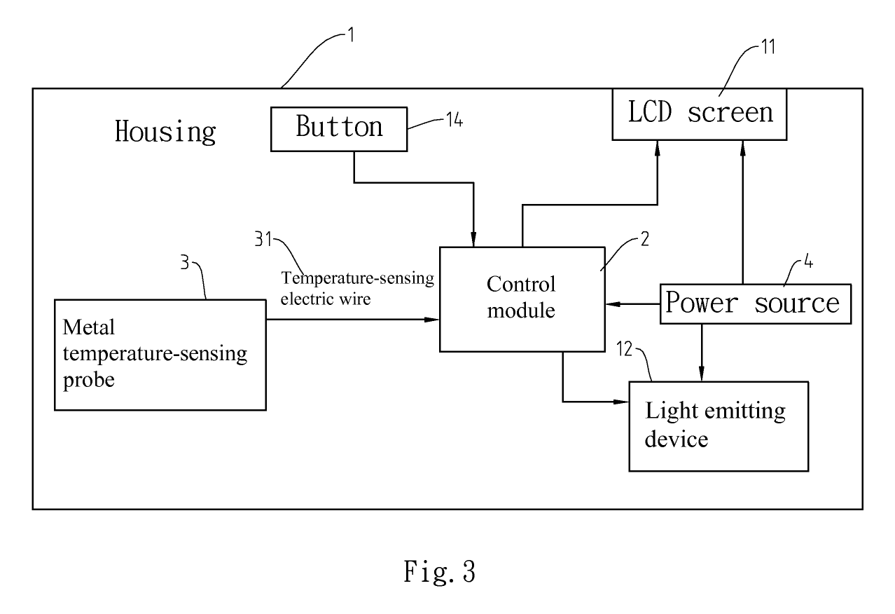

FIG. 4 is a schematic drawing showing one design alert icon in the alert display zone according to the present invention.

FIG. 5 is a schematic drawing showing another design of alert icon in the alert display zone according to the present invention.

FIG. 6 is a schematic sectional side view of an alternate form of the thermometer in accordance with the present invention.

FIG. 7 illustrates the outer appearance of an electronic thermometer according to the prior art.

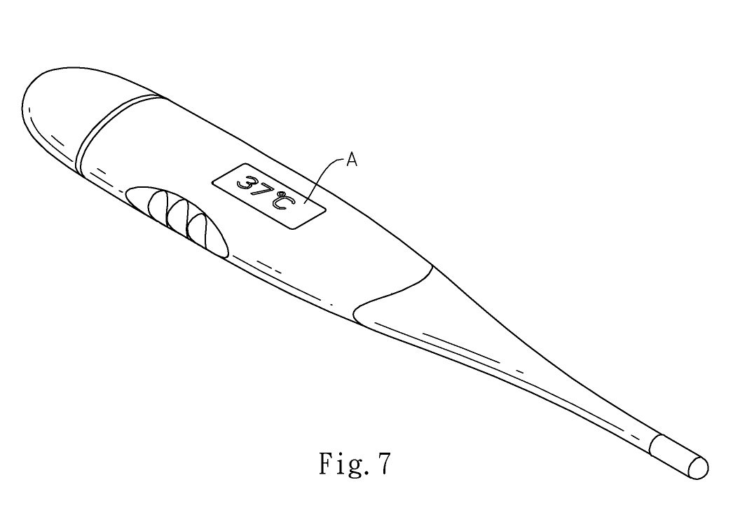

FIG. 8 illustrates digits displayed on a LCD panel according to the prior art.

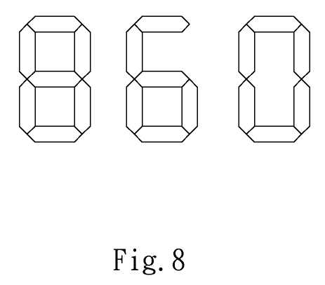

### DETAILED DESCRIPTION OF THE PREFERRED EMBODIMENT

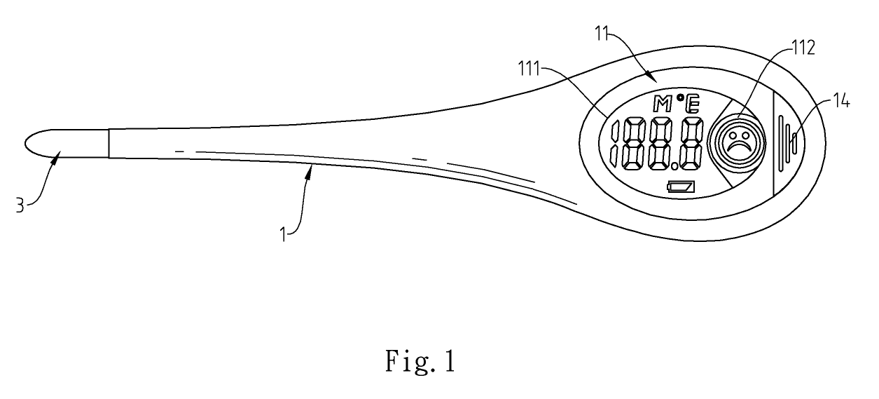

Referring to FIGS. 1˜4, a thermometer in accordance with the present invention is shown comprising a housing 1, a control module 2, a metal temperature sensing probe 3 and a power source 4.

The housing 1 is molded from a plastic material having a low coefficient of thermal conductivity, having a LCD screen 11 and a button 14 mounted on one side, namely, the top side thereof. The LCD screen 11 comprises a temperature display zone 111 for body temperature indication, and an alert display zone 112 separated from the temperature display zone 111. The temperature display zone 111 and the alert display zone 112 have different background colors for easy identification. The background color of the alert display zone 112 can be made by means of printing a color coating material on or adhering a color film to the top or bottom surface of the cover glass of the LCD screen 11 or a part of the housing 1. Further, a light emitting device 12 is installed in the housing 1 adjacent to one side of the alert display zone 112 of the LCD screen 11. The light emitting device 12 can be a LED (light emitting diode). Further, an alert icon 1121 is provided at the alert display zone 112.

The control module 2 is mounted inside the housing 1, and electrically connected with the light emitting device 12, the button 14 and the LCD screen 11. Further, the control module 2 has stored therein a predetermined reference temperature value.

The metal temperature-sensing probe 3 is fixedly connected to one end of the housing 1 and electrically connected to the control module 2 through a temperature-sensing electric wire 31.

The power source 4 is accommodated in the housing 1 and electrically connected to the control module 2, the LCD screen 11 and the light emitting device 12 to provide them with the necessary working voltage. Further, the power source 4 can be a button cell battery.

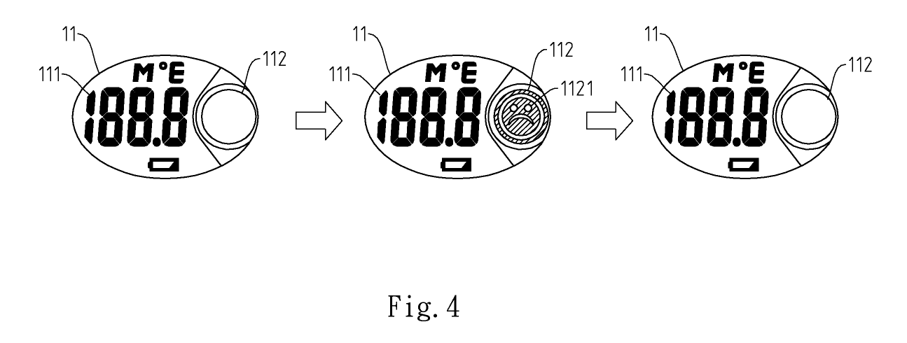

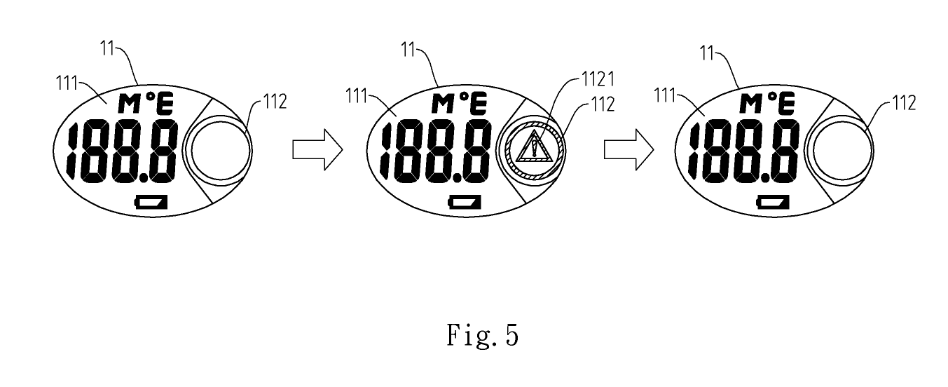

When using the thermometer, press the button 14 to start up the control module 2. When the metal temperature-sensing probe 3 is held in contact with the user's body, the user's body temperature is transferred to the metal temperature-sensing probe 3 and then the control module 2 via the temperature-sensing electric wire 31. At this time, the control module 2 converts the detected analog temperature signal into a digital temperature signal and sends the digital temperature signal to the LCD screen 11 for display on the temperature display zone 111. When displaying the detected body temperature value, the control module 2 compares the detected body temperature value to the predetermined reference temperature value. When the detected body temperature value surpasses the predetermined reference temperature value, the control module 2 drives the light emitting device 12 and the alert icon 1121 to give off light constantly or to flash. Because the background color of the alert display zone 112 of the LCD screen 11 is different from that of the temperature display zone 111, the indication of the alert icon 1121 can be noted clearly. Further, the light emitting device 12 effectively lights up the alert display zone 112, enabling the user to know the indication of the alert icon 1121. Further, the alert icon 1121 can be made having any of a variety of designs. FIG. 4 shows one design of the alert icon 1121. FIG. 5 shows another design of the alert icon 1121. After each use of the thermometer, press the button 14 again to switch off the control module 2.

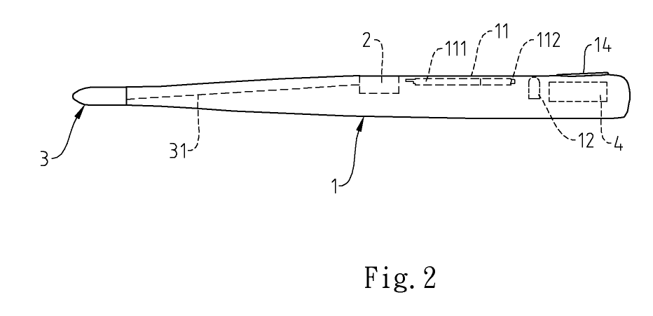

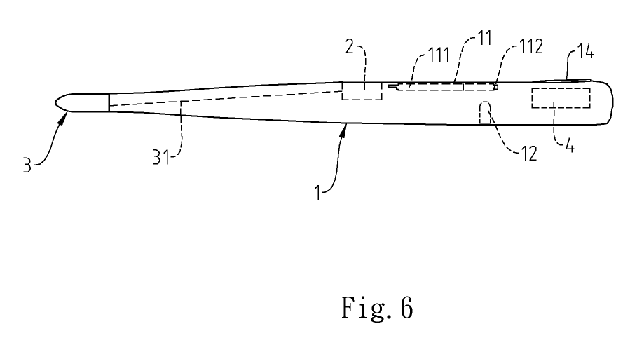

FIG. 6 shows an alternate form of the thermometer in accordance with the present invention. This alternate form is substantially similar to that shown in FIG. 2 with the exception that the light emitting device 12 is provided beneath the alert display zone 112. When the light emitting device 12 is turned on, it effectively lights up the alert display zone 112, giving a visual warning signal that the body temperature measured is over the predetermined reference temperature value.

In conclusion, the technical feature of the present invention is that the control module 2 has stored therein a predetermined reference temperature value; when the thermometer is used to measure the body temperature of a person, the control module 2 compares the detected body temperature value to the predetermined reference temperature value and then drives the light emitting device 12 and the alert display zone 112 to give off light constantly or to flash, if the comparison result shows that the detected body temperature value surpassed the predetermined reference temperature value, giving a visual warning signal. Because the alert display zone 112 is separated from the temperature display zone 111, the user can know the situation in case of hyperthermia.

A prototype of thermometer with warning function has been constructed with the features of FIGS. 1˜7. The thermometer functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A thermometer for measuring the body temperature of a person and producing a visual warning signal when the measured body temperature surpassed a predetermined reference temperature value, the thermometer comprising a housing, a control module, a metal temperature sensing probe and a power source, wherein
said housing carries a LCD screen, said LCD screen comprising a temperature display zone for displaying the body temperature of a person been measured and an alert display zone separated from said temperature display zone for displaying an alert icon, said temperature display zone and said alert display zone having different background colors;
said control module is mounted inside said housing and electrically connected with said LCD screen and said metal temperature sensing probe and adapted to receive a detected analog temperature signal from said metal temperature sensing probe, to convert the analog temperature signal into a digital temperature data, to drive on said temperature display zone for the display of the digital temperature data, and to compare the value of the digital temperature data with a predetermined reference temperature value stored therein and to drive on said alert display zone of said LCD screen in giving a visual alert signal when the value of the digital temperature data surpasses the predetermined reference temperature value;
said metal temperature sensing probe is fixedly fastened to one end of said housing and electrically connected to said control module through a temperature-sensing electric wire thereof;
said power source is mounted in said housing and electrically connected with said control module and said LCD screen to provide said control module and said LCD screen with the necessary working voltage.

2. The thermometer as claimed in claim 1, further comprising a button mounted on an outside wall of said housing and electrically connected with said control module for pressing by a user to switch on/off said control module.

3. The thermometer as claimed in claim 1, wherein said power source is a button cell battery.

4. The thermometer as claimed in claim 1, wherein the background color of said alert display zone is a color coating printed on one of top and bottom surface of said LCD screen and a part of said housing.

5. The thermometer as claimed in claim 1, wherein the background color of said alert display zone is a color film adhered to one of top and bottom surface of said LCD screen and a part of said housing.

6. The thermometer as claimed in claim 1, further comprising a light emitting device mounted in one lateral side relative to said alert display zone and electrically connected to said control module and controllable by said control module to light up said alert display zone.

7. The thermometer as claimed in claim 1, further comprising a light emitting device mounted in a bottom side relative to said alert display zone and electrically connected to said control module and controllable by said control module to light up said alert display zone.
